(19) United States
(12) Patent Application Publication
(10) Pub. No.: US 2004/0074133 A1
(43) Pub. Date: Apr. 22, 2004

(54) Fisherman's helper

(76) Inventor: Robert A. Hampton, Louisville, KY (US)

Correspondence Address: Robert A. Hampton, 6008 Moorhaven Dr., Louisville, KY, 40219, US

(21) Appl. No.: 10/196,906

(22) Filed: Oct. 21, 2002

(51) Int. Cl. A01K 97/12

(52) U.S. Cl. 43/15

(57) ABSTRACT

The “Fisherman's Helper” is used as a supplement to the standard fishing pole to allow the pole to “set” a hook in the fish's mouth using the recoil of the fishing pole with no required action from the fisherman at the point of a fish taking the bait. The assembly is designed to stay together under constant tension and to separate during periods of varied pressure such as a fish taking the baited hook and pulling against the set pole. When properly set up, the “Fisherman's Helper” will allow fish to be hooked without manual intervention at the point the fish takes the bait. This will allow people who desire to catch fish to do so even when distracted by other tasks undertaken while fishing. When properly set up, the “Fisherman's Helper” will allow fish to be hooked without manual intervention at the point the fish takes the bait. This will allow people who desire to enjoy fishing and catch fish to do so even when distracted by other tasks undertaken while fishing.

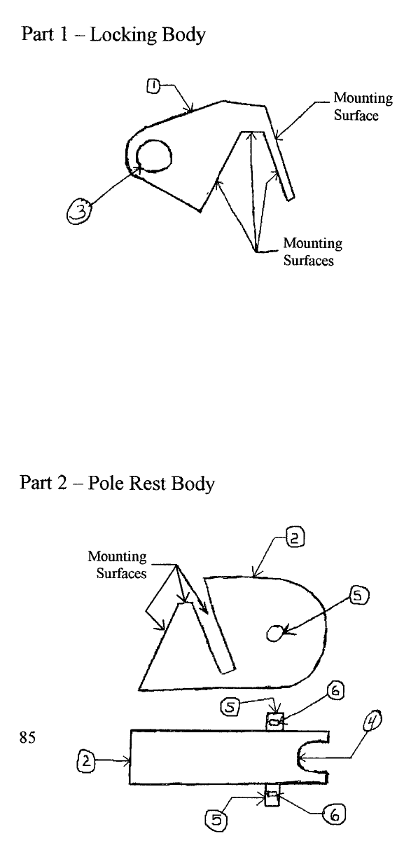

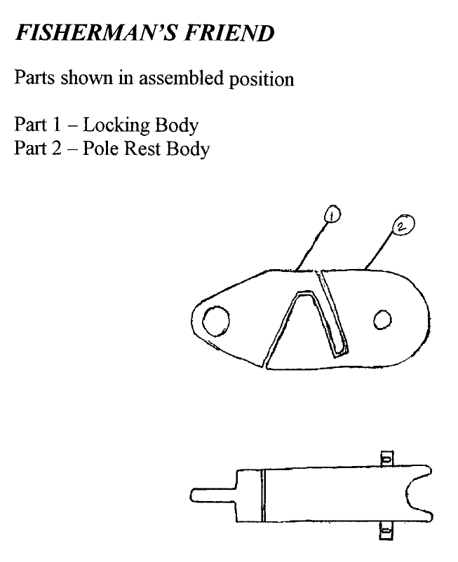

The assembly is set up by using a string to attach part 1 to an object on the ground, fishing reel, or other items below the location where the tip of the fishing pole will be leaned or supported. Part 2 is attached to the fishing pole 6-12″ below the tip end using rubber bands to secure it. The pole must be secured to the ground in a manner that will allow it to be bent, providing tension against the line, and located within reach of part 1 when the pole is bent. The two halves of the fisherman's friend are then put together as shown in the assembly diagram to maintain tension on the pole.

When correctly setup, parts 1 and 2 will separate when there is any additional tension applied to the tip of the pole, i.e. when a fish is taking the bait, and the tension stored in the pole will be used to “set” the hook.

Part 1—Locking Body Functional Description:

This part is described to have a hole (Item 3) to be used for attaching a string and 4 “mounting surfaces” that will provide one half of the functional joint for operation of the assembly. The angles are derived from testing of materials and situations, and may be varied for other applications. All other surfaces of this part are for manufacturing and handling.

Part 2—Pole Rest Body Functional Description:

This part is described to have a pole rest slot for attachment to the fishing pole. The end of the part that has the pole rest slot (Item 4) is to be fill radius to support all angles of attachment to the pole. It also has 2 posts (Items 5) that are used to secure the part to the fishing pole using rubber bands or similar items. Each post has an indentation (Items 6) to aid in securing the rubber band. This part also has 4 “mounting surfaces” that are opposite to part one and form the other half of the functional joint.

1: An assembled fishing device of 2 parts each having 4 mounting surfaces designed to separate when tension, which is applied during setup, is released, such as would occur when a fish is taking the bait.

2: The assembled fishing device according to claim 1 uses specific and proportional angles on the mounting surfaces of each part to achieve the proper holding and separating tensions for use in the assembled condition on the fishing pole.
